(19) United States
(12) Patent Application Publication
(10) Pub. No.: US 2025/0313063 A1
(43) Pub. Date: Oct. 9, 2025

(54) HEAT PUMP SYSTEM FOR A VEHICLE

(71) Applicants: HYUNDAI MOTOR COMPANY, Seoul (KR); KIA CORPORATION, Seoul (KR); HANON SYSTEMS, Daejeon (KR); DOOWON CLIMATE CONTROL CO., LTD., Asan-si (KR)

(72) Inventors: Hoyoung Jeong, Hwaseong-si (KR); Hyungjun Lee, Hwaseong-si (KR); Seo Jung Kim, Hwaseong-si (KR); Jungha Park, Hwaseong-si (KR); Yong Woong Cha, Hwaseong-si (KR); Jae Yeon Kim, Hwaseong-si (KR); Man Hee Park, Hwaseong-si (KR); Youhwan Park, Hwaseong-si (KR); Joongsu Yun, Hwaseong-si (KR); Yun Jin Kim, Daejeon (KR); Hae Jun Lee, Daejeon (KR); Beom Seok Joo, Daejeon (KR); Daehui Lee, Asan-si (KR); Seong Wan Jeong, Asan-si (KR); Chul Min Kim, Asan-si (KR); Mingyu Lee, Asan-si (KR); Gyuyeong Jeong, Asan-si (KR)

(73) Assignees: HYUNDAI MOTOR COMPANY, Seoul (KR); KIA CORPORATION, Seoul (KR); HANON SYSTEMS, Daejeon (KR); DOOWON CLIMATE CONTROL CO., LTD., Asan-si (KR)

(21) Appl. No.: 18/911,644

(22) Filed: Oct. 10, 2024

(30) Foreign Application Priority Data
Apr. 9, 2024 (KR) 10-2024-0047977

(51) Int. Cl. B60H 1/32; B60H 1/00

(52) U.S. Cl. CPC B60H 1/32284; B60H 1/00278; B60H 1/00885; B60H 1/323; B60H 2001/00307

(57) ABSTRACT

A heat pump system for a vehicle may be capable of performing cooling or heating of an interior of the vehicle by using a natural refrigerant and efficiently adjusting the temperature of a battery module by using one chiller where a refrigerant and a coolant exchange heat. The system includes an air conditioner unit with a compressor, a first heat-exchanger, a second heat-exchanger, a first expansion valve, and a third heat-exchanger that are connected through the refrigerant line to circulate a refrigerant through the refrigerant line. The system also includes a chiller connected to the refrigerant line through the first connection 10 line. The chiller is configured to adjust a temperature of a coolant by heat-exchanging the coolant with the refrigerant supplied from the air conditioner unit.

### CROSS-REFERENCE TO RELATED APPLICATION

This application claims priority to and the benefit of Korean Patent Application No. 10-2024-0047977 filed in the Korean Intellectual Property Office on Apr. 9, 2024, the entire contents of which are incorporated herein by reference.

### BACKGROUND

### (a) Field of the Disclosure

The present disclosure relates to a heat pump system for a vehicle. More particularly, the present disclosure relates to a heat pump system for a vehicle capable of cooling or heating a vehicle interior by using a natural refrigerant and efficiently adjusting the temperature of a battery module by using one chiller where a refrigerant and a coolant exchange heat.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle. This is achieved by heat-exchange using a condenser and an evaporator in a process in which a refrigerant discharged by driving a compressor is circulated back to the compressor through the condenser, a receiver drier, an expansion valve, and the evaporator.

In other words, the air conditioner unit lowers the temperature and a humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

Environment-friendly technology of a vehicle is a core technology of the future automobile industry. Advanced car makers have focused their energy on the development of an environmentally-friendly vehicle to achieve or meet environmental and fuel efficiency regulations.

Recently, in accordance with a continuous increased interest in energy efficiency and environmental pollution, the development of an environmentally-friendly vehicle capable of substantially substituting for an internal combustion engine vehicle is desirable. Environmentally-friendly vehicles are classified into electric vehicles driven using a fuel cell or electricity as a power source and hybrid vehicles driven using an engine and a battery.

Electric vehicles are in the spotlight as a means of transportation for the future to solve environmental problems and energy resource problems.

A heat pump system, which is an air conditioner apparatus for regulating the temperature of the vehicle interior, is applied to such an electric vehicle. However, the refrigerant that is conventionally used in the heat pump system contains a large amount of environmentally regulated material, e.g., PFAS (Perfluoroalkyl and Polyfluoroalkyl Substances). Therefore, there is a demand for the development of a system capable of controlling the temperature of the vehicle interior by using new refrigerants, without PFAS and flammability issues, or natural refrigerants.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a heat pump system for a vehicle designed to perform cooling or heating of the vehicle interior by using a natural refrigerant in order to cope with the environmental regulations, and by efficiently adjusting the temperature of the battery module by using one chiller where a refrigerant and a coolant exchange heat.

In addition, the heat pump system is designed to maximize the cooling and heating performance by operating not only in the supercritical region, in which the pressure and temperature of the refrigerant is higher than a threshold pressure and temperature, but also in the subcritical region, by applying an R744 refrigerant that is a natural refrigerant using carbon dioxide.

A heat pump system for a vehicle may include an air conditioner unit having a compressor, a first heat-exchanger, a second heat-exchanger, a first expansion valve, and a third heat-exchanger that are connected through a refrigerant line to circulate a refrigerant through the refrigerant line. The heat pump system also includes a chiller connected to the refrigerant line through a first connection line. The chiller is configured to adjust a temperature of the coolant by heat-exchanging a coolant with the refrigerant supplied from the air conditioner unit. The air conditioner unit may include a control device provided on the refrigerant line between the first heat-exchanger and the second heat-exchanger. The air conditioner unit may also include a second connection line having a first end connected to the refrigerant line between the compressor and the first heat-exchanger and a second end connected to the control device. The air conditioner unit may also include a third connection line having a first end connected to the refrigerant line between the first heat-exchanger and the second heat-exchanger and a second end connected to the refrigerant line between the second heat-exchanger and the third heat-exchanger. The air conditioner unit may also include a fourth connection line having a first end connected to the refrigerant line between the second heat-exchanger and the third heat-exchanger and a second end connected to the refrigerant line between the third heat-exchanger and the compressor. The air conditioner unit may also include a fifth connection line having a first end connected to the refrigerant line between the third heat-exchanger and the compressor and a second end connected to the refrigerant line between the first heat-exchanger and the second heat-exchanger.

The air conditioner unit may further include a sixth connection line having a first end connected to the third connection line and a second end connected to a first end of the fourth connection line, a first valve provided on the refrigerant line between the third heat-exchanger and the compressor, a second valve provided on the third connection line, a third valve provided on the fifth connection line, a fourth valve provided on the sixth connection line, a second expansion valve provided on the first connection line, and a third expansion valve provided on the fourth connection line.

The air conditioner unit may further include an accumulator provided on the refrigerant line between the third heat-exchanger and the compressor, and an internal heat-exchanger provided inside the accumulator. The internal heat-exchanger may be configured to exchange heat between the refrigerant supplied from the second heat-exchanger and the refrigerant supplied from the third heat-exchanger with each other, and to supply the refrigerant with a higher temperature among the heat-exchanged refrigerant to the third heat-exchanger.

When cooling of a battery module is required in a cooling mode of a vehicle interior, a portion of the refrigerant line connecting the compressor and the first heat-exchanger and a portion of the refrigerant line connecting the first heat-exchanger and the control device may be closed by an operation of the control device. The first connection line may be opened by an operation of the second expansion valve, the second connection line may be opened by the operation of the control device, the third connection line may be closed by an operation of the second valve, the fourth connection line may be closed by an operation of the third expansion valve, the fifth connection line may be closed by an operation of the third valve, and the sixth connection line may be closed by an operation of the fourth valve.

The first expansion valve may be configured to expand the refrigerant introduced through the refrigerant line and to introduce the expanded refrigerant to the third heat-exchanger The second expansion valve may be configured to expand the refrigerant introduced through the first connection line and introduce the expanded refrigerant to the chiller so as to cool the battery module by using the coolant having exchanged heat with the refrigerant at the chiller.

The refrigerant discharged from the compressor may be introduced into the control device along the second connection line. The refrigerant discharged from the control device may be introduced into the second heat-exchanger. A partial refrigerant among the refrigerant discharged from the internal heat-exchanger may be introduced into the chiller along the first connection line. A remaining refrigerant among the refrigerant discharged from the internal heat-exchanger may be introduced into the first expansion valve along the refrigerant line. The refrigerant discharged from the chiller and the refrigerant discharged from the third heat-exchanger may be supplied to the compressor, after passing through the internal heat-exchanger and the accumulator along the refrigerant line.

In a heating mode of a vehicle interior, a portion of the refrigerant line connecting a first end of the first connection line to a second end of the third connection line may be closed by an operation of the first expansion valve. A portion of the refrigerant line connecting a first end of the third connection line to the control device may be closed by an operation of the control device. A portion of the refrigerant line connecting the control device and a second end of the fifth connection line may be closed by the operation of the control device. A portion of the refrigerant line connecting a second end of the fourth connection line and a second end of the first connection line may be closed by an operation of the first valve. The first connection line may be opened by an operation of the second expansion valve, the second connection line may be closed by the operation of the control device, the third connection line may be opened by an operation of the second valve, the fourth connection line may be opened by an operation of the third expansion valve, the fifth connection line may be opened by an operation of the third valve, and the sixth connection line may be closed by an operation of the fourth valve.

The third expansion valve may be configured to expand the refrigerant such that the expanded refrigerant may be supplied to the second heat-exchanger, the internal heat-exchanger, and the chiller, respectively.

A partial refrigerant among the refrigerant introduced from the third heat-exchanger to the fourth connection line may be introduced into the second heat-exchanger. A remaining refrigerant among the refrigerant introduced from the third heat-exchanger to the fourth connection line may be introduced into the internal heat-exchanger.

A partial refrigerant among the refrigerant discharged from the third expansion valve may be introduced into the chiller, after passing through the internal heat-exchanger along the refrigerant line. The refrigerant discharged from the second heat-exchanger and the chiller may be supplied to the compressor, after passing through the internal heat-exchanger and the accumulator.

The second expansion valve may be configured to supply the refrigerant introduced through the first connection line to the chiller without expansion.

In a heating and dehumidification mode of a vehicle interior, a portion of the refrigerant line connecting a first end of the first connection line and a second end of the third connection line may be opened by an operation of the first expansion valve. A portion of the refrigerant line connecting a first end of the third connection line and the second heat-exchanger may be closed by an operation of the control device. The refrigerant line connecting the third heat-exchanger and the accumulator may be opened by an operation of the first valve. A portion of the refrigerant line connecting the second heat-exchanger and the internal heat-exchanger may be closed. The first connection line may be closed by an operation of the second expansion valve, the second connection line may be closed by the operation of the control device, a portion of the third connection line connected to the sixth connection line from the first end of the third connection line is opened, a portion of the third connection line connecting the second end of the third connection line to a first end of the sixth connection line may be closed by an operation of the second valve, the fourth connection line may be closed by an operation of the third expansion valve, the fifth connection line may be closed by an operation of the third valve, and the sixth connection line may be opened by an operation of the fourth valve.

The first expansion valve may be configured to expand the refrigerant introduced from the first heat-exchanger through the third connection line, the sixth connection line, and the refrigerant line. The first expansion valve may also be configured to supply the expanded refrigerant to the third heat-exchanger.

The second heat-exchanger and the third heat-exchanger may be configured to cool or evaporate the interiorly introduced refrigerant.

A first end of the first connection line may be connected to the refrigerant line between the second heat-exchanger and the first expansion valve. A second end of the first connection line may be connected to the refrigerant line between the third heat-exchanger and the compressor. A second end of the second connection line may be connected to the refrigerant line between the first heat-exchanger and the second heat-exchanger.

The control device may include a first control valve provided on the refrigerant line between the first heat-exchanger and the second heat-exchanger, and a second control valve provided on the second connection line. The second control valve may be configured to control a flow of the refrigerant flowing through the second connection line.

The control device may include a first control valve provided on the refrigerant line between the first heat-exchanger and the second heat-exchanger, and a second control valve provided on the second connection line. The second control valve may be configured to selectively expand the refrigerant flowing through the second connection line. A fifth valve is provided on the refrigerant line between the second heat-exchanger and a second end of the fifth connection line.

In a hot gas heating mode of a vehicle interior, a portion of the refrigerant line connecting a first end of the first connection line to a second end of the third connection line may be closed by an operation of the first expansion valve. A portion of the refrigerant line connecting a first end of the third connection line to the control device may be closed by an operation of the control device. A portion of the refrigerant line connecting the control device and the second end of the fifth connection line may be opened by the operation of the control device. A portion of the refrigerant line connecting a second end of the fourth connection line and a second end of the first connection line may be closed by an operation of the first valve. A portion of the refrigerant line connected to the first end of the fourth connection line by passing through the second heat-exchanger from the second end of the fifth connection line may be closed by an operation of the fifth valve. The first connection line may be opened by an operation of the second expansion valve, the second connection line may be opened by the operation of the control device, the third connection line may be opened by an operation of the second valve, the fourth connection line may be opened by an operation of the third expansion valve, the fifth connection line may be opened by an operation of the third valve, and the sixth connection line may be closed by an operation of the fourth valve.

A partial refrigerant among the refrigerant supplied from the compressor may be introduced into the first heat-exchanger along the refrigerant line. A remaining refrigerant among the refrigerant supplied from the compressor may be introduced into the control device along the second connection line. The control device may be configured to expand the refrigerant introduced into the second connection line such that the expanded refrigerant may flow along the fifth connection line. The third expansion valve may be configured to expand the refrigerant such that the expanded refrigerant may be supplied to the internal heat-exchanger and the chiller, respectively. The second expansion valve may be configured to supply the refrigerant introduced through the first connection line to the chiller without expansion.

The refrigerant may be an R744 refrigerant formed of carbon dioxide.

The chiller may be connected to the electrical component and the battery module through the first line and the second line through which the coolant circulates.

The first heat-exchanger, the second heat-exchanger, and the third heat-exchanger may be air-cooled gas coolers that exchange the interiorly introduced refrigerant with the air. The chiller may be a water-cooled gas cooler that exchanges the interiorly introduced refrigerant with the air.

The first expansion valve, the second expansion valve, and the third expansion valve may be electronic expansion valves that selectively expand the refrigerant while controlling the flow of the refrigerant.

As described above, according to an embodiment of a heat pump system for a vehicle, it is possible to cope with environmental regulations and improve the overall marketability of a vehicle by performing cooling or heating of the vehicle interior by using a natural refrigerant.

In addition, according to the disclosure, by applying the R744 refrigerant that is a natural refrigerant using carbon dioxide, cooling and heating performance may be maximized by operating the system not only in the supercritical region, in which the pressure and temperature of the refrigerant is higher than a threshold pressure and temperature, but also in the subcritical region, at the time of cooling and heating of the vehicle interior.

In addition, according to the disclosure, streamlining and simplification of the system may be achieved by efficiently adjusting the temperature of a battery module by using a single chiller that exchanges heat between the coolant and the refrigerant according to the mode of the vehicle.

In addition, according to an embodiment, by efficiently adjusting the temperature of the battery module, the optimal performance of the battery module may be enabled, and the overall travel distance of the vehicle may be increased due to the efficient management of the battery module.

In addition, according to the present disclosure, through streamlining of an entire system, it is possible to reduce manufacturing cost and weight and to improve space utilization.

### BRIEF DESCRIPTION OF THE DRAWINGS

FIG. 1 is a block diagram of a heat pump system for a vehicle according to an embodiment.

FIG. 2 is a schematic diagram of a control device in a heat pump system for a vehicle according to an embodiment.

FIG. 3 is a schematic diagram of a control device in a heat pump system for a vehicle according to another embodiment.

FIG. 4 is an operation diagram of a heat pump system for a vehicle, according to an embodiment, for cooling a battery module in a cooling mode of a vehicle interior.

FIG. 5 is an operation diagram according to a heating mode of a vehicle interior in a heat pump system for a vehicle according to an embodiment.

FIG. 6 is an operation diagram according to a heating and dehumidification mode of a vehicle interior in a heat pump system for a vehicle according to an embodiment.

FIG. 7 is an operation diagram according to a hot gas heating mode of a vehicle interior in a heat pump system for a vehicle according to another embodiment.

### DETAILED DESCRIPTION OF THE EMBODIMENTS

Embodiments of the present disclosure are hereinafter described in detail with reference to the accompanying drawings.

The various embodiments disclosed in the present specification and the constructions depicted in the drawings are only example embodiments of the present disclosure, and do not cover the entire scope of the present disclosure. Therefore, it should be understood that there may be various equivalents and variations at the time of applying the technical concepts of this specification.

In order to clarify the present disclosure, parts that are not related to the description have been omitted. Also, the same elements or equivalents are referred to with the same reference numerals throughout the specification.

Also, the size and thickness of each element may be arbitrarily shown in the drawings and the present disclosure is not necessarily limited thereto. Further, in the drawings, the thickness of layers, films, panels, regions, etc., may be exaggerated for clarity.

In addition, unless explicitly described to the contrary, the term “comprise” and variations thereof, such as “comprises” or “comprising”, should be understood to imply the inclusion of stated elements but not the exclusion of any other elements. The same understanding should apply to similar terms such as “have,” “include”, and the like.

Furthermore, terms, such as “ . . . unit”, “ . . . means”, “ . . . portions”, “ . . . part”, and “ . . . member” described in the specification, mean a unit of a comprehensive element that performs at least one function or operation. The refrigerant line disclosed and described herein may be referred to in sections or portions, such as first refrigerant line, second refrigerant line, etc. to distinguish segments of the refrigerant line that may be described as being disposed between various parts and components of the system.

When a component, device, element, or the like of the present disclosure is described as having a purpose or performing an operation, function, or the like, the component, device, or element should be considered herein as being “configured to” meet that purpose or perform that operation or function.

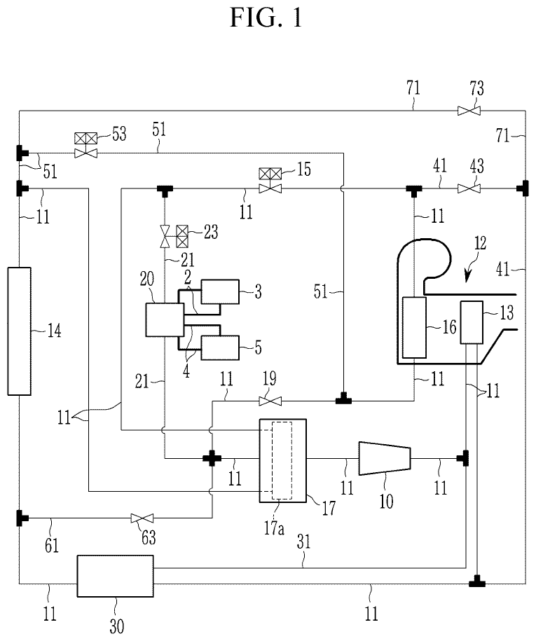

FIG. 1 is a block diagram of a heat pump system for a vehicle according to an embodiment.

A heat pump system for a vehicle according to an embodiment may perform cooling or heating of a vehicle interior by using a natural refrigerant in compliance with environmental regulations and may efficiently adjust a temperature of a battery module 5 by using one chiller 20 where the refrigerant and a coolant exchange heat with each other.

The refrigerant may be an R744 refrigerant formed of carbon dioxide, which has an ozone depletion potential (ODP) of 0 and a global warming potential (GWP) of 1.

In other words, according to an embodiment of a heat pump system for a vehicle, by applying the R744 refrigerant, which is a natural refrigerant utilizing carbon dioxide, the system may operate not only in the supercritical region, in which the pressure and temperature of the refrigerant is higher than a threshold pressure and temperature, but also in the subcritical region, thereby maximizing cooling and heating performance.

For such a purpose, the heat pump system according to an embodiment may include an air conditioner unit and the chiller 20.

Referring to FIG. 1, the air conditioner unit may include a compressor 10 connected through the refrigerant line 11 so as to circulate the refrigerant through the refrigerant line 11. The air conditioner unit may also include a first heat-exchanger 13, a second heat-exchanger 14, a third heat-exchanger 16, an accumulator 17, and an internal heat-exchanger 17a.

First, the compressor 10 may compress the introduced refrigerant and flow the compressed refrigerant to the refrigerant line 11 such that the refrigerant may circulate along the refrigerant line 11.

The first heat-exchanger 13 may exchange heat between the air and the refrigerant selectively supplied from the compressor 10.

The second heat-exchanger 14 may be connected to the first heat-exchanger 13 through the refrigerant line 11. Accordingly, the refrigerant supplied to the refrigerant line 11 may pass through the second heat-exchanger 14.

The second heat-exchanger 14 may be disposed in the front side of the vehicle and may cool or evaporate the refrigerant through heat-exchange with the air introduced from the outside during driving of the vehicle.

Since a supercritical state of the R744 refrigerant does not have a phase change unlike a typical refrigerant, the term “gas cooling” may be used instead of the term “condensation”.

In an embodiment, the first expansion valve 15 may be provided, i.e., disposed, on or along the refrigerant line 11 between the second heat-exchanger 14 and the third heat-exchanger 16. The first expansion valve 15 may selectively expand the refrigerant introduced through the refrigerant line 11.

In addition, the third heat-exchanger 16 may be provided on the refrigerant line 11 between the first expansion valve 15 and the compressor 10.

The first heat-exchanger 13 and the third heat-exchanger 16 may be provided inside a heating, ventilation, and air-conditioning (HVAC) module 12.

Accordingly, the third heat-exchanger 16 may cool or evaporate the refrigerant through heat-exchange with the air introduced into the HVAC module 12.

In other words, the first heat-exchanger 13, the second heat-exchanger 14, and the third heat-exchanger 16 may be an air-cooled gas cooler that exchanges heat between the air and the interiorly introduced refrigerant.

The second heat-exchanger 14 and the third heat-exchanger 16 may evaporate the refrigerant when the expanded refrigerant is introduced and may cool the refrigerant when the unexpanded refrigerant is introduced.

In an embodiment, the accumulator 17 may be provided on the refrigerant line 11 between the third heat-exchanger 16 and the compressor 10.

The accumulator 17 may supply only the gaseous refrigerant to the compressor 10. The efficiency and durability of the compressor 10 may bet thereby improved.

In addition, the internal heat-exchanger 17a may be provided inside the accumulator 17. The internal heat-exchanger 17a may exchange heat between the refrigerant supplied from the second heat-exchanger 14 and the refrigerant supplied from the third heat-exchanger 16. The internal heat-exchanger may supply the refrigerant with a higher temperature among the heat-exchanged refrigerant to the third heat-exchanger 16.

In other words, the internal heat-exchanger may exchange heat between the refrigerant cooled at the second heat-exchanger 14 and the low-temperature refrigerant discharged from the third heat-exchanger 16. The internal heat-exchanger may supply the heat-exchanged refrigerant to the compressor 10 and the third heat-exchanger 16, respectively.

In an embodiment, the chiller 20 may be connected to an electrical component 3 through a first line 2 through which the coolant circulates.

The electrical component 3 may include a power conversion device such as an electric power control unit (EPCU), a motor, an inverter, an on-board charger (OBC), an autonomous driving controller, or the like.

The electrical component 3 configured as such may be connected to the first line 2 and cooled in a water-cooled manner.

The chiller 20 may adjust a temperature of the electrical component 3 by using the coolant having exchanged heat with the refrigerant and may recollect a waste heat of the electrical component 3.

In addition, the chiller 20 may be connected to the battery module 5 through a second line 4 through which the coolant circulates. Accordingly, the coolant may selectively circulate inside the chiller 20.

The chiller 20 may adjust a temperature of the coolant by exchanging heat between the coolant with the refrigerant supplied from the air conditioner unit. In other words, the chiller 20 may be a water-cooled gas cooler configured to exchange heat between the interiorly introduced refrigerant with the coolant.

The chiller 20 may be connected to the refrigerant line 11 through a first connection line 21.

A first end of the first connection line 21 may be connected to the refrigerant line 11 between the second heat-exchanger 14 and the first expansion valve 15. In addition, a second end of the first connection line 21 may be connected to the refrigerant line 11 between the third heat-exchanger 16 and the accumulator 17.

In other words, the chiller 20 may adjust the temperature of the coolant by exchanging heat with the coolant selectively introduced through the first line 2 or the second line 4 with the refrigerant selectively supplied from the air conditioner unit.

Accordingly, the coolant having exchanged heat in the chiller 20 may circulate through the electrical component 3 through the first line 2. In addition, the coolant having exchanged heat in the chiller 20 may circulate through the battery module 5 through the second line 4.

A water pump (not shown) may be provided on the first line 2 and the second line 4.

In other words, the coolant may circulate through the first line 2 and the second line 4 according to the operation of respective water pumps (not shown). Accordingly, the coolant having exchanged heat with the refrigerant in the chiller 20 may be selectively supplied to the electrical component 3 and the battery module 5, and thereby may adjust the temperature of the electrical component 3 and the battery module 5.

, In an embodiment, the air conditioner unit may further include a first valve 19, a second expansion valve 23, a control device 30, a second connection line 31, a third connection line 41, a second valve 43, a fourth connection line 51, a third expansion valve 53, a fifth connection line 61, a third valve 63, a sixth connection line 71, and a fourth valve 73.

First, the first valve 19 may be provided on the refrigerant line 11 between the third heat-exchanger 16 and the compressor 10. In more detail, the first valve 19 may be provided on the refrigerant line 11 between the third heat-exchanger 16 and the accumulator 17.

The first valve 19 may open the refrigerant line 11 such that the refrigerant discharged from the third heat-exchanger 16 may be introduced into the accumulator 17. In another configuration, the first valve 19 may close the refrigerant line 11 such that the refrigerant discharged from the third heat-exchanger 16 may not be introduced into the accumulator 17.

In other words, in a heating mode of the vehicle interior, the first valve 19 may close the refrigerant line 11 such that the refrigerant discharged from the third heat-exchanger 16 may not be introduced into the accumulator 17.

On the other hand, in a cooling mode of the vehicle interior, or a heating and dehumidification mode of the vehicle interior, the first valve 19 may open the refrigerant line 11 such that the refrigerant discharged from the third heat-exchanger 16 may be introduced into the accumulator 17.

The second expansion valve 23 may be provided on the first connection line 21.

Depending on the cooling mode or heating mode of the vehicle interior, the second expansion valve 23 may selectively expand the refrigerant introduced into the first connection line 21 and flow the expanded refrigerant to the chiller 20.

In addition, the second expansion valve 23 may supply the refrigerant introduced into the first connection line 21 to the chiller 20 without expansion or may close the first connection line 21 such that the refrigerant may not be supplied to the chiller 20.

In more detail, for cooling the battery module 5 by using the coolant having exchanged heat with the refrigerant at the chiller 20, the second expansion valve 23 may open the first connection line 21. At the same time, the second expansion valve 23 may expand the refrigerant introduced into the first connection line 21 and introduce the expanded refrigerant into the chiller 20.

In other words, the second expansion valve 23 may expand the refrigerant discharged from the second heat-exchanger 14 and introduce the expanded refrigerant in the state of having decreased its temperature to the chiller 20. The temperature of the coolant passing through the interior of the chiller 20 may thereby be further decreased.

Accordingly, the coolant having a temperature that has been lowered while passing through the chiller 20 may be introduced into the battery module 5, thereby achieving more efficient cooling.

In an embodiment, the control device 30 may be provided on the refrigerant line 11 between the first heat-exchanger 13 and the second heat-exchanger 14.

A first end of the second connection line 31 may be connected to the refrigerant line 11 between the compressor 10 and the first heat-exchanger 13. A second end of the second connection line 31 may be connected to the control device 30.

In more detail, the second end of the second connection line 31 may be connected to the refrigerant line 11 through the control device 30, between the first heat-exchanger 13 and the second heat-exchanger 14.

Accordingly, each of the refrigerant line 11 and the second connection line 31 may be connected to the control device 30.

The control device 30 configured as such may control the flow of the refrigerant and may selectively expand the refrigerant depending on different configurations.

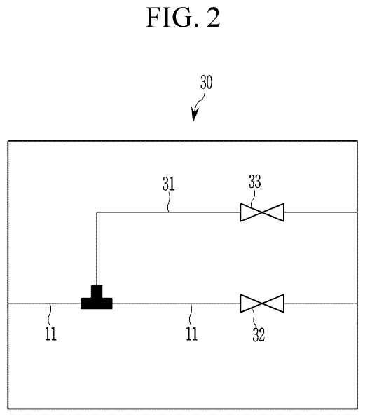

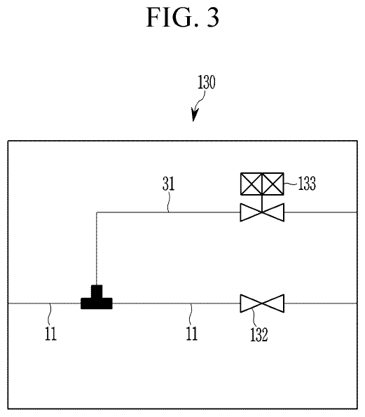

As shown in FIG. 2 and FIG. 3, the control device 30 may vary in configuration, as depicted by first and second embodiments.

First, as shown in FIG. 2, the control device 30 according to a first embodiment may include a first control valve 32 and a second control valve 33.

The first control valve 32 may be provided on the refrigerant line 11 between the first heat-exchanger 13 and the second heat-exchanger 14.

The first control valve 32 may selectively open and close the refrigerant line 11 such that the refrigerant discharged from the first heat-exchanger 13 may be selectively introduced into the second heat-exchanger 14.

In addition, the second control valve 33 may be provided on the second connection line 31. The second control valve 33 may selectively open and close the second connection line 31.

In other words, in the cooling mode of the vehicle interior, the second control valve 33 may open the second connection line 31. On the other hand, in the heating mode of the vehicle interior and the heating and dehumidification mode of the vehicle interior, the second control valve 33 may close the second connection line 31.

The first control valve 32 and the second control valve 33 may be 2-way valves that control opening and closing of the refrigerant line 11 and the second connection line 31, respectively.

In the cooling mode of the vehicle interior, the control device 30 according to a first embodiment configured as such may close the refrigerant line 11 connected to the first heat-exchanger 13. At the same time, the control device 30 may open the second connection line 31 and the refrigerant line 11 connected to the second heat-exchanger 14, respectively.

To the contrary, in the heating mode of the vehicle interior, or the heating and dehumidification mode of the vehicle interior, the control device 30 may close the refrigerant line 11 and the second connection line 31.

As shown in FIG. 3, the control device 130 according to a second embodiment may include a first control valve 132 and a second control valve 133.

First, the first control valve 132 may be provided on the refrigerant line 11 between the first heat-exchanger 13 and the second heat-exchanger 14.

The first control valve 132 may selectively open and close the refrigerant line 11 such that the refrigerant discharged from the first heat-exchanger 13 may be selectively introduced into the second heat-exchanger 14.

The first control valve 132 may be a 2-way valve configured to control opening and closing of the refrigerant line 11.

In addition, the second control valve 133 may be provided on the second connection line 31. The second control valve 133 may selectively open and close the second connection line 31. The second control valve 133 may selectively expand the refrigerant flowing through the second connection line 31.

The second control valve 133 may be an electronic expansion valve that selectively expands the refrigerant while controlling the flow of the refrigerant.

In other words, in the cooling mode of the vehicle interior, the second control valve 133 may open the second connection line 31. On the other hand, in the heating mode of the vehicle interior and the heating and dehumidification mode of the vehicle interior, the second control valve 133 may close the second connection line 31.

In the hot gas heating mode of the vehicle interior, the second control valve 133 according to the second embodiment may open the second connection line 31 and may expand the refrigerant introduced into the second connection line 31.

In other words, in the cooling mode of the vehicle interior, the control device 130 according to the second embodiment configured as such may close the refrigerant line 11 connected to the first heat-exchanger 13. At the same time, the control device 130 may open the second connection line 31 and the refrigerant line 11 connected to the second heat-exchanger 14, respectively.

To the contrary, in the heating mode of the vehicle interior or the heating and dehumidification mode of the vehicle interior, the control device 130 may close the refrigerant line 11 and the second connection line 31.

In addition, in the hot gas heating mode of the vehicle interior, the control device 130 may close the refrigerant line 11 connected to the first heat-exchanger 13 and may open the refrigerant line 11 connected to the second heat-exchanger 14. At the same time, the control device 130 may open the second connection line 31 and may expand the refrigerant introduced into the second connection line 31.

When the control device 130 according to the second embodiment is applied, a fifth valve 80 may be further provided on the refrigerant line 11 between the control device 130 and the second heat-exchanger 14.

In an embodiment, a first end of the third connection line 41 may be connected to the refrigerant line 11 between the first heat-exchanger 13 and the second heat-exchanger 14. A second end of the third connection line 41 may be connected to the refrigerant line 11 between the second heat-exchanger 14 and the third heat-exchanger 16.

The second valve 43 may be provided on the third connection line 41. The second valve 43 may selectively open and close the third connection line 41, so as to control the flow of the refrigerant through the third connection line 41.

In the cooling mode of the vehicle interior, the second valve 43 may close the third connection line 41. On the other hand, in the heating mode of the vehicle interior, the second valve 43 may open the third connection line 41.

In addition, in the heating and dehumidification mode of the vehicle interior, the second valve 43 may close a portion of second connection line 31 such that the refrigerant supplied from the first heat-exchanger may not be introduced into the third heat-exchanger 16.

A first end of the fourth connection line 51 may be connected to the refrigerant line 11 between the second heat-exchanger 14 and the third heat-exchanger 16. A second end of the fourth connection line 51 may be connected to the refrigerant line 11 between the third heat-exchanger 16 and the accumulator 17.

The third expansion valve 53 may be provided on the fourth connection line 51.

The third expansion valve 53 may control the flow of the refrigerant by selectively opening and closing the fourth connection line 51 and may selectively expand the refrigerant introduced into the fourth connection line 51.

In other words, in the heating mode of the vehicle interior, the third expansion valve 53 may open the fourth connection line 51, expand the refrigerant introduced into the fourth connection line 51, and supply the expanded refrigerant to the second heat-exchanger 14 and the internal heat-exchanger 17a, respectively.

Accordingly, in the heating mode of the vehicle interior, the second heat-exchanger 14 may evaporate the refrigerant through exchanging heat with the air introduced from the outside.

The refrigerant having passed through the internal heat-exchanger 17a may be supplied to the chiller 20. The chiller 20 may evaporate the refrigerant through exchanging heat with the coolant supplied through the first line 2.

To the contrary, in the cooling mode of the vehicle interior, or the heating and dehumidification mode of the vehicle interior, the third expansion valve 53 may close the fourth connection line 51.

In an embodiment, a first end of the fifth connection line 61 may be connected to the refrigerant line 11 between the third heat-exchanger 16 and the compressor 10. A second end of the fifth connection line 61 may be connected to the refrigerant line 11 between the first heat-exchanger 13 and the second heat-exchanger 14.

In addition, the third valve 63 may be provided on the fifth connection line 61. The third valve 63 may control the flow of the refrigerant by selectively opening and closing the fifth connection line 61.

In the cooling mode of the vehicle interior, or the heating and dehumidification mode of the vehicle interior, the third valve 63 may close the fifth connection line 61. To the contrary, in the heating mode of the vehicle interior, the third valve 63 may open the fifth connection line 61.

In an embodiment, a first end of the sixth connection line 71 may be connected to the third connection line 41. More specifically, the first end of the sixth connection line 71 may be connected to the third connection line 41 between the first end of the third connection line 41 and the second valve 43.

A second end of the sixth connection line 71 may be connected to the first end of the fourth connection line 51.

In addition, the fourth valve 73 may be provided on the sixth connection line 71. The fourth valve 73 may control the flow of the refrigerant by selectively opening and closing the sixth connection line 71.

The first valve 19, the second valve 43, the third valve 63, and the fourth valve 73 may be 2-way valves configured to control opening and closing of the refrigerant line 11, the third connection line 41, the fifth connection line 61, and the sixth connection line 71, respectively.

In addition, the first expansion valve 15, the second expansion valve 23, and the third expansion valve 53 may be electronic expansion valves that selectively expand the refrigerant while controlling the flow of the refrigerant.

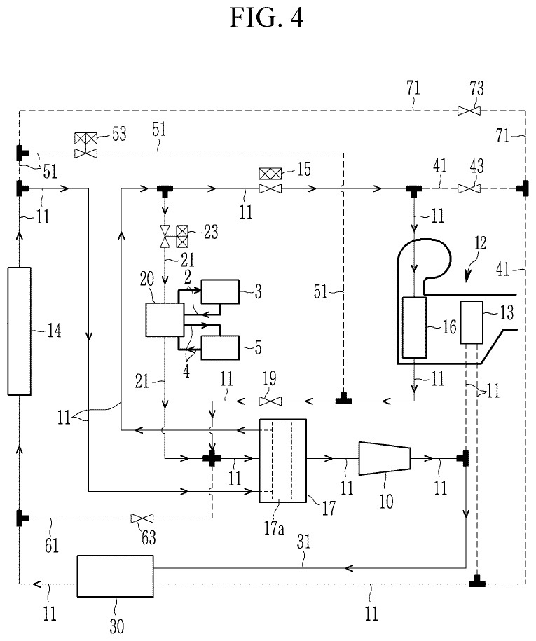

Hereinafter, an operation and action of a heat pump system for a vehicle according to an embodiment configured as described above is described in detail with reference to FIGS. 4-7.

First, the operation for cooling the battery module 5 in the cooling mode of the vehicle interior is described below in detail with reference to FIG. 4.

FIG. 4 is an operation diagram according to an embodiment of a heat pump system for a vehicle, for cooling a battery module in the cooling mode of the vehicle interior.

Referring to FIG. 4, the coolant may circulate through the first line 2 by an operation of a water pump (not shown). At the same time, the coolant may circulate through the second line 4 by an operation of a water pump (not shown).

In other words, the coolant having passed through the electrical component 3 may be supplied to the chiller 20 along the first line 2, and the coolant having passed through the battery module 5 may be supplied to the chiller 20 along the second line 4.

In the air conditioner unit, respective components may operate in order to cool the vehicle interior. Accordingly, the refrigerant may circulate along the refrigerant line 11.

A portion of the refrigerant line 11 connecting the compressor 10 and the first heat-exchanger 13 and a portion of the refrigerant line 11 connecting the first heat-exchanger 13 and the control device 30 may be closed by an operation of the control device 30.

For cooling the electrical component 3 and the battery module 5, the first connection line 21 may be opened by an operation of the second expansion valve 23.

Accordingly, the coolant having passed through the battery module 5 may be supplied to the chiller 20 along the second line 4.

The second expansion valve 23 may expand the refrigerant introduced through the first connection line 21 and introduce the expanded refrigerant to the chiller 20 so as to cool the battery module 5 by using the coolant having exchanged heat with the refrigerant at the chiller 20.

Accordingly, the coolant having passed through the chiller 20 may be cooled through exchanging heat with the expanded refrigerant supplied to the chiller 20.

In other words, the coolant passing through the chiller 20 may be cooled through exchanging heat with the expanded refrigerant supplied to the chiller 20. The coolant cooled at the chiller 20 may be supplied to the battery module 5 along the second line 4. Accordingly, the battery module 5 may be efficiently cooled by the coolant cooled in the chiller 20.

The second connection line 31 may be opened by the operation of the control device 30. In addition, the third connection line 41 may be closed by an operation of the second valve 43.

Therefore, the refrigerant discharged from the compressor 10 may be introduced into the control device 30 along the second connection line 31.

In addition, the fourth connection line 51 may be closed by an operation of the third expansion valve 53. The fifth connection line 61 may be closed by an operation of the third valve 63. In addition, the sixth connection line 71 may be closed by an operation of the fourth valve 73.

Accordingly, the refrigerant discharged from the compressor 10 may flow along the second connection line 31 without passing through the first heat-exchanger 13.

In other words, the refrigerant discharged from the compressor 10 may be introduced into the control device 30 while flowing along the second connection line 31. Thereafter, the refrigerant may be introduced into the second heat-exchanger 14 along the refrigerant line 11 connected to the second heat-exchanger 14 from the control device 30.

The second heat-exchanger 14 may primarily cool the refrigerant by using the air introduced from the outside.

The refrigerant discharged from the second heat-exchanger 14 may be introduced into the internal heat-exchanger 17a along the refrigerant line 11. The internal heat-exchanger 17a may additionally cool the refrigerant supplied from the second heat-exchanger 14 through exchanging heat with the refrigerant supplied from the third heat-exchanger 16 and the chiller 20.

A partial refrigerant among the refrigerant discharged from the internal heat-exchanger 17a may be introduced into the chiller 20 along the first connection line 21.

The refrigerant introduced into the chiller 20 may exchange heat with the coolant supplied through the second line 4 and may be introduced into the compressor 10 after passing through the internal heat-exchanger 17a and the accumulator 17 through the refrigerant line 11 connected to the first connection line 21.

In addition, a remaining refrigerant among the refrigerant discharged from the internal heat-exchanger 17a may be introduced into the first expansion valve 15 along the refrigerant line 11 to cool the vehicle interior.

The first expansion valve 15 may expand the refrigerant introduced through the refrigerant line 11 and introduce the expanded refrigerant to the third heat-exchanger 16.

The refrigerant having passed through the third heat-exchanger 16 may sequentially pass through the internal heat-exchanger 17a, the accumulator 17, and the compressor 10 along the refrigerant line 11.

In other words, the refrigerant discharged from the chiller 20 and the refrigerant discharged from the third heat-exchanger 16 may be supplied to the compressor 10, after passing through the internal heat-exchanger 17a and the accumulator 17 along the refrigerant line 11.

The air introduced into the HVAC module 12 may be cooled while passing through the third heat-exchanger 16 by the refrigerant of the low-temperature state introduced into the third heat-exchanger 16.

The cooled air may cool the vehicle interior by being directly introduced into the vehicle interior.

The refrigerant having a cooling level that has been increased while sequentially passing through the second heat-exchanger 14 and the internal heat-exchanger 17a may be expanded and supplied to the third heat-exchanger 16.

In an embodiment, the second heat-exchanger 14 may cool the refrigerant through exchanging heat with the air, and the internal heat-exchanger 17a may additionally cool the refrigerant through exchanging heat with the low-temperature refrigerant.

By such an operation, the heat pump system may more efficiently cool the R744 refrigerant made of carbon dioxide, and accordingly, the phase change heat transfer section of the refrigerant may be more secured.

In addition, the refrigerant having secured more phase change heat transfer sections may be evaporated in the third heat-exchanger 16. Accordingly, the temperature of the air passing through the third heat-exchanger 16 may be further lowered, thereby improving the cooling performance and efficiency.

While repeatedly performing the above-described processes, in the cooling mode of the vehicle interior, the refrigerant may cool the vehicle interior, and at the same time, may cool the coolant through exchanging heat while passing through the chiller 20.

The low-temperature coolant cooled by the chiller 20 may be introduced into the battery module 5 through the second line 4. Accordingly, the battery module 5 may be efficiently cooled by the supplied low-temperature coolant.

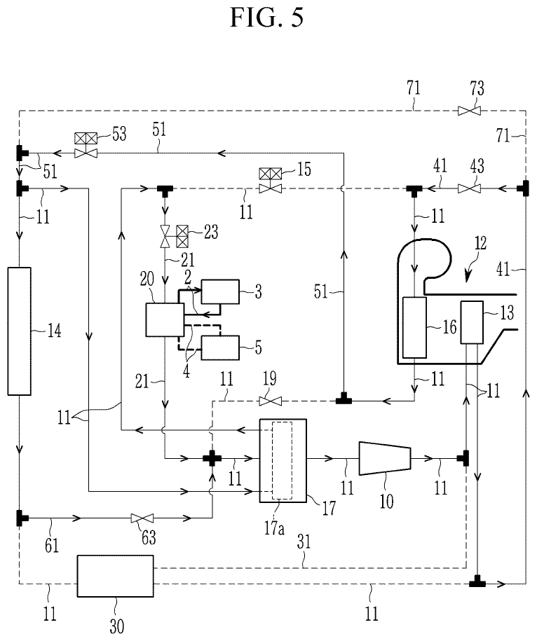

In an embodiment, the operation in the heating mode of the vehicle interior is described in detail below with reference to FIG. 5.

FIG. 5 is an operation diagram according to an embodiment of a heating mode of a vehicle interior in a heat pump system for a vehicle.

Referring to FIG. 5, the coolant may circulate through the first line 2 by an operation of a water pump (not shown).

Accordingly, the coolant having passed through the electrical component 3 may be supplied to the chiller 20 along the first line 2.

In the air conditioner unit, respective components may operate in order to heat the vehicle interior. Accordingly, the refrigerant may circulate along the refrigerant line 11.

A portion of the refrigerant line 11 connecting the first end of the first connection line 21 to the second end of the third connection line 41 may be closed by an operation of the first expansion valve 15.

A portion of the refrigerant line 11 connecting the first end of the third connection line 41 to the control device 30 may be closed by the operation of the control device 30.

A portion of the refrigerant line 11 connecting the control device 30 and the second end of the fifth connection line 61 may be closed by the operation of the control device 30.

In addition, a portion of the refrigerant line 11 connecting the second end of the fourth connection line 51 and the second end of the first connection line 21 may be closed by an operation of the first valve 19.

Simultaneously, the first connection line 21 may be opened by the operation of the second expansion valve 23. The second expansion valve 23 may supply the refrigerant introduced through the first connection line 21 to the chiller 20 without expansion.

The second connection line 31 may be closed by the operation of the control device 30. The third connection line 41 may be opened by the operation of the second valve 43.

Accordingly, the first heat-exchanger 13 and the third heat-exchanger 16 may cool the refrigerant supplied from the compressor 10 by using the air introduced into the HVAC module 12.

In an embodiment, the fourth connection line 51 may be opened by the operation of the third expansion valve 53.

Accordingly, a partial refrigerant among the refrigerant introduced from the third heat-exchanger 16 to the fourth connection line 51 may be introduced into the second heat-exchanger 14.

Simultaneously, a remaining refrigerant among the refrigerant introduced from the third heat-exchanger 16 to the fourth connection line 51 may be introduced into the internal heat-exchanger 17a along the refrigerant line 11. The third expansion valve 53 may expand the refrigerant such that the expanded refrigerant may be supplied to the second heat-exchanger 14, the internal heat-exchanger 17a, and the chiller 20, respectively.

Accordingly, the second heat-exchanger 14 may evaporate the expanded refrigerant through exchanging heat with the externally introduced air. The second heat-exchanger 14 may recollect the ambient air heat while evaporating the expanded refrigerant through exchanging heat with the air.

In addition, the chiller 20 may evaporate the expanded refrigerant through exchanging heat with the coolant supplied through the first line 2. The chiller 20 may recollect the waste heat of the electrical component 3 from the coolant having a temperature that has been increased by recollecting the waste heat from the electrical component 3.

In addition, the fifth connection line 61 may be opened by the operation of the third valve 63. In addition, the sixth connection line 71 may be closed by the operation of the fourth valve 73.

Accordingly, the refrigerant discharged from the second heat-exchanger 14 may flow along the fifth connection line 61, and the refrigerant discharged from the chiller 20 may flow along the first connection line 21.

The refrigerant flowing through the first connection line 21 and the fifth connection line 61 may be supplied to the compressor 10, after passing through the internal heat-exchanger 17a and the accumulator 17 along the refrigerant line 11.

In other words, a partial refrigerant among the refrigerant expanded at the third expansion valve 53 may be introduced into the chiller 20, after passing through the internal heat-exchanger 17a along the refrigerant line 11.

In addition, the refrigerant discharged from the second heat-exchanger 14 and the chiller 20 may be supplied to the compressor 10, after passing through the internal heat-exchanger 17a and the accumulator 17.

In such a state, the refrigerant supplied from the compressor 10 may be introduced into the first heat-exchanger 13 along the refrigerant line 11. The refrigerant having passed through the first heat-exchanger 13 may flow along the third connection line 41 connected to the refrigerant line 11.

The refrigerant flowing along the third connection line 41 may be introduced into the third heat-exchanger 16 along the refrigerant line 11 connected to the third heat-exchanger 16.

The first heat-exchanger 13 and the third heat-exchanger 16 may cool the refrigerant by exchanging heat between the refrigerant and the air introduced inside HVAC module 12. The refrigerant primarily cooled at the first heat-exchanger 13 may be additionally cooled in the third heat-exchanger 16.

In other words, when the refrigerant, having passed through the first heat-exchanger 13, is supplied to the third heat-exchanger 16, the third heat-exchanger 16 may cool the refrigerant by exchanging heat between the refrigerant and the air introduced inside HVAC module 12.

The refrigerant having passed through the third heat-exchanger 16 may flow along the opened fourth connection line 51. The refrigerant introduced into the fourth connection line 51 may be expanded by the operation of the third expansion valve 53.

The partial refrigerant among the refrigerant expanded at the third expansion valve 53 may be introduced into the internal heat-exchanger 17a while flowing along the refrigerant line 11 connected to the internal heat-exchanger 17a.

The refrigerant having passed through the internal heat-exchanger 17a may pass through the chiller 20 along the refrigerant line 11 and the first connection line 21, and then pass through the internal heat-exchanger 17a and the accumulator 17.

A remaining refrigerant among the refrigerant expanded at the third expansion valve 53 may pass through the second heat-exchanger 14, and then flow along the fifth connection line 61. The refrigerant flowing through the fifth connection line 61 may pass through the internal heat-exchanger 17a and the accumulator 17, together with the refrigerant having passed through the chiller 20.

Accordingly, the second heat-exchanger 14 may evaporate the supplied refrigerant through exchanging heat with the air, and at the same time, the chiller 20 may evaporate the supplied refrigerant through exchanging heat with the coolant.

While repeatedly performing such an operation, the second heat-exchanger 14 and the chiller 20 may recollect the ambient air heat and the waste heat of the electrical component 3.

In other words, the heat pump system may use the recollected waste heat of the electrical component 3 and the ambient air heat in order to increase the temperature of the refrigerant, thereby reducing the power consumption of the compressor 10 and improving heating efficiency.

The refrigerant having passed through the accumulator 17 may be supplied to the compressor 10.

In addition, the refrigerant compressed into the high-temperature and high-pressure state by the compressor 10 may be introduced back into the first heat-exchanger 13 along the refrigerant line 11.

As described above, the refrigerant supplied to the first heat-exchanger 13 and the third heat-exchanger 16, respectively, may increase the temperature of the air introduced into the HVAC module 12.

Accordingly, the air introduced from the outside may be converted into the high-temperature state while sequentially passing through the third heat-exchanger 16 and the first heat-exchanger 13, and then may be introduced into the vehicle interior, thereby achieving heating of the vehicle interior.

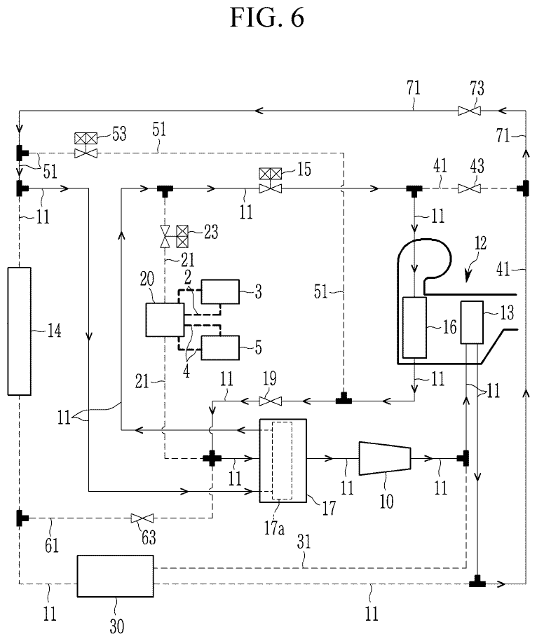

In an embodiment, the operation in the heating and dehumidification mode of the vehicle interior is described below in detail with reference to FIG. 6.

FIG. 6 is an operation diagram according to an embodiment of a heating and dehumidification mode of a vehicle interior in a heat pump system for a vehicle.

Referring to FIG. 6, in the air conditioner unit, respective components may operate in order to heat and dehumidify the vehicle interior. Accordingly, the refrigerant may circulate along the refrigerant line 11.

A portion of the refrigerant line 11 connecting the first end of the first connection line 21 and the second end of the third connection line 41 may be opened by the operation of the first expansion valve 15.

In addition, a portion of the refrigerant line 11 connecting the first end of the third connection line 41 and the second heat-exchanger 14 may be closed by the operation of the control device 30.

The refrigerant line 11 connecting the third heat-exchanger 16 and the accumulator 17 may be opened by the operation of the first valve 19. In addition, a portion of the refrigerant line 11 connecting the second heat-exchanger 14 and the internal heat-exchanger 17a may be closed.

The first connection line 21 may be closed by the operation of the second expansion valve 23. The second connection line 31 may be closed by the operation of the control device 30.

A portion of the third connection line 41 connecting the second end of the third connection line 41 to the first end of the sixth connection line 71 may be closed by the operation of the second valve 43.

The fourth connection line 51 may be closed by the operation of the third expansion valve 53. The fifth connection line 61 may be closed by the operation of the third valve 63.

In addition, the sixth connection line 71 may be opened by the operation of the fourth valve 73.

The first expansion valve 15 may expand the refrigerant introduced from the first heat-exchanger 13 through the third connection line 41, the sixth connection line 71, and the refrigerant line 11. Thereafter, the first expansion valve 15 may supply the expanded refrigerant to the third heat-exchanger 16.

In other words, the refrigerant discharged from the compressor 10 may be introduced into the first heat-exchanger 13 along the refrigerant line 11. The first heat-exchanger 13 may cool the refrigerant supplied from the compressor 10 by using the air introduced into the HVAC module 12.

The refrigerant having passed through the first heat-exchanger 13 may flow along the third connection line 41 connected to the refrigerant line 11.

The refrigerant having flowed along the third connection line 41 may flow to the sixth connection line 71. Thereafter, the refrigerant may be introduced into the internal heat-exchanger 17a along the refrigerant line 11 connected to the internal heat-exchanger 17a.

The refrigerant having passed through the internal heat-exchanger 17a may be supplied to the first expansion valve 15 along the refrigerant line 11. The first expansion valve 15 may expand the refrigerant.

The refrigerant expanded at the first expansion valve 15 may be supplied to the third heat-exchanger 16 along the refrigerant line 11.

The air introduced into the HVAC module 12 may be cooled while passing through the third heat exchanger 16 by the refrigerant of the low-temperature state introduced into the third heat-exchanger 16. Thereafter, the refrigerant having passed through the third heat-exchanger 16 may pass through the internal heat-exchanger 17a and the accumulator 17 along the refrigerant line 11.

The internal heat-exchanger 17a may additionally cool the refrigerant supplied from the first heat-exchanger 13 through exchanging heat with the refrigerant supplied from the third heat-exchanger 16.

In addition, the refrigerant having passed through the accumulator 17 may be supplied to the compressor 10. Thereafter, the refrigerant compressed into the high-temperature and high-pressure state by the compressor 10 may be introduced back into the first heat-exchanger 13 along the refrigerant line 11.

As described above, the refrigerant supplied to the first heat-exchanger 13 may increase the temperature of the air introduced into the HVAC module 12.

In other words, the air introduced into the HVAC module 12 may be dehumidified while passing through the third heat-exchanger 16, by the refrigerant of the low-temperature state introduced into the third heat-exchanger 16. Thereafter, the air is converted to a high-temperature state while passing through the first heat-exchanger 13 and then introduced into the vehicle interior, thereby smoothly heating and dehumidifying the vehicle interior.

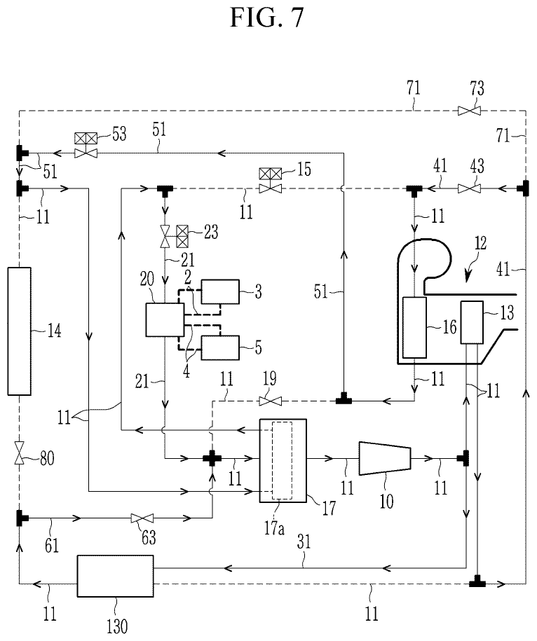

In addition, in a heat pump system according to another embodiment applied with the control device 130 (see FIG. 3) according to a second embodiment, an operation in the hot gas heating mode of the vehicle interior is described in detail below with reference to FIG. 7.

FIG. 7 is an operation diagram according to a hot gas heating mode of a vehicle interior in a heat pump system for a vehicle according to another embodiment.

Referring to FIG. 7, when the ambient air heat, the waste heat of the electrical component 3, and a waste heat of the battery module 5 are not sufficient, the heat pump system according to another embodiment may not recollect heat. In other words, when heating of the vehicle interior is required while the external temperature is low and the heat generated from the electrical component 3 and the battery module 5 is not sufficient in an early stage of driving the vehicle, the heat pump system may perform heating of the vehicle interior by directly using the high-pressure and high-temperature refrigerant.

As such, heating the vehicle interior by using only the refrigerant may be referred to as the hot gas heating mode.

The heat pump system according to another embodiment is the same as an embodiment described above, except for the detailed configuration of the control device 130 and the fifth valve 80.

In another embodiment, the fifth valve 80 may be provided on the refrigerant line 11 between the second heat-exchanger 14 and the second end of the fifth connection line 61.

Referring to FIG. 7, the coolant does not circulate along the first line 2 and the second line 4.

In the air conditioner unit, respective components may operate for the hot gas heating mode of the vehicle interior operation. Accordingly, the refrigerant may circulate along the refrigerant line 11.

A portion of the refrigerant line 11 connecting the first end of the first connection line 21 to the second end of the third connection line 41 may be closed by the operation of the first expansion valve 15.

A portion of the refrigerant line 11 connecting the first end of the third connection line 41 to the control device 130 may be closed by an operation of the control device 130.

A portion of the refrigerant line 11 connecting the control device 130 and the second end of the fifth connection line 61 may be opened by the operation of the control device 130.

A portion of the refrigerant line 11 connecting the second end of the fourth connection line 51 and the second end of the first connection line 21 may be closed by the operation of the first valve 19.

A portion of the refrigerant line 11 connected to the first end of the fourth connection line 51 by passing through the second heat exchanger 14 from the second end of the fifth connection line 61 may be closed by an operation of the fifth valve 80.

Simultaneously, the first connection line 21 may be opened by the operation of the second expansion valve 23. The second expansion valve 23 may supply the refrigerant introduced through the first connection line 21 to the chiller 20 without expansion.

In addition, the second connection line 31 may be opened by the operation of the control device 130.

Accordingly, a partial refrigerant among the refrigerant supplied from the compressor 10 may be introduced into the first heat-exchanger 13 along the refrigerant line 11.

A remaining refrigerant among the refrigerant supplied from the compressor 10 may be introduced into the control device 130 along the second connection line 31.

The control device 130 may expand the refrigerant supplied from the compressor 10 through the second connection line 31. The expanded refrigerant may flow to the refrigerant line 11 connected to the fifth connection line 61.

The third connection line 41 may be opened by the operation of the second valve 43. The fourth connection line 51 may be opened by the operation of the third expansion valve 53. The third expansion valve 53 may expand the refrigerant such that the expanded refrigerant may be supplied to the internal heat-exchanger 17a and the chiller 20, respectively.

The fifth connection line 61 may be opened by the operation of the third valve 63. In other words, the control device 130 may expand the refrigerant introduced into the second connection line 31 such that the expanded refrigerant may flow along the fifth connection line 61.

In addition, the sixth connection line 71 may be closed by the operation of the fourth valve 73.

Accordingly, a partial refrigerant among the refrigerant compressed at the compressor 10 may be introduced into the first heat-exchanger 13 along the refrigerant line 11. The refrigerant having passed through the first heat-exchanger 13 may be introduced into the third heat-exchanger 16 along the refrigerant line 11, after flowing along the third connection line 41.

The first heat-exchanger 13 and the third heat-exchanger 16 may cool the refrigerant by heat-exchanging the refrigerant with the air introduced inside HVAC module 12. The refrigerant primarily cooled at the first heat-exchanger 13 may be additionally cooled in the third heat-exchanger 16.

The refrigerant supplied to the first heat-exchanger 13 and the third heat-exchanger 16, respectively, may increase the temperature of the air introduced into the HVAC module 12.

Accordingly, the air introduced from the outside may be converted into the high-temperature state while sequentially passing through the third heat-exchanger 16 and the first heat-exchanger 13, and then may be introduced into the vehicle interior, thereby heating the vehicle interior.

The refrigerant discharged from the third heat-exchanger 16 may flow along the refrigerant line 11 connected to the internal heat-exchanger 17a, after flowing along the opened fourth connection line 51.

The third expansion valve 53 may expand the refrigerant introduced from the third heat-exchanger 16 along the fourth connection line 51. The refrigerant expanded at the third expansion valve 53 may pass through the internal heat-exchanger 17a while flowing along the refrigerant line 11.

The refrigerant having passed through the internal heat-exchanger 17a may pass through the chiller 20 along the opened first connection line 21. The refrigerant having passed through the chiller 20 may flow along the first connection line 21.

The refrigerant flowing through the first connection line 21 and the fifth connection line 61 may be supplied to the compressor 10, after passing through the internal heat-exchanger 17a and the accumulator 17 along the refrigerant line 11.

The refrigerant discharged from the compressor 10 may flow to the refrigerant line 11 and the second connection line 31, respectively, and may repeatedly perform the above-described operation.

In an embodiment, when the external temperature is low and the heat source is not sufficient in an early stage of driving the vehicle, the vehicle interior may be heated by using the high-temperature refrigerant supplied from the compressor 10.

Therefore, as described above, according to an embodiment of a heat pump system for a vehicle, it is possible to cope with environmental regulations and improve the overall marketability of the vehicle by performing cooling or heating of the vehicle interior by using the natural refrigerant.

In addition, according to the disclosure, by applying the R744 refrigerant that is a natural refrigerant using carbon dioxide, cooling and heating performance may be maximized by being operated not only in the supercritical region, in which the pressure and temperature of the refrigerant is higher than a threshold pressure and temperature, but also in the subcritical region, for cooling and heating of the vehicle interior.

In addition, according to the disclosure, streamlining and simplification of the system may be achieved by efficiently adjusting the temperature of the battery module 5 by using the single chiller 20 that exchanges heat between the coolant and the refrigerant according to the mode of the vehicle.

In addition, according to an embodiment, by efficiently adjusting the temperature of the battery module 5, the optimal performance of the battery module 5 may be enabled, and the overall travel distance of the vehicle may be increased due to the efficient management of the battery module 5.

In addition, according to the present disclosure, through streamlining of an entire system, it is possible to reduce manufacturing cost and weight and to improve space utilization.

While technical concepts of this disclosure has been described in connection with what is presently considered to be practical embodiments, it is to be understood that the disclosure is not limited to the disclosed embodiments. On the contrary, the present disclosure is intended to cover various modifications and equivalent arrangements included within the spirit and scope of the appended claims.

### DESCRIPTION OF SYMBOLS

2, 4: first and second line
3: electrical component
5: battery module
10: compressor
11: refrigerant line
12: HVAC module
13, 14, 16: first, second, and third heat-exchanger
15: first expansion valve
17: accumulator
17a: internal heat-exchanger
19: first valve
20: chiller
21: first connection line
23: second expansion valve
30, 130: control device
31: second connection line
32, 132: first control valve
33, 133: second control valve
41: third connection line
43: second valve
51: fourth connection line
53: third expansion valve
61: fifth connection line
63: third valve
71: sixth connection line
73: fourth valve
80: fifth valve

What is claimed is:

1. A heat pump system for a vehicle, the heat pump system comprising:
a refrigerant line;
a first connection line;
an air conditioner unit including a compressor, a first heat-exchanger, a second heat-exchanger, a first expansion valve, and a third heat-exchanger that are connected through the refrigerant line to circulate a refrigerant through the refrigerant line; and
a chiller connected to the refrigerant line through the first connection line, the chiller configured to adjust a temperature of a coolant by heat-exchanging the coolant with the refrigerant supplied from the air conditioner unit,
wherein the air conditioner unit further includes:
a control device disposed on the refrigerant line between the first heat-exchanger and the second heat-exchanger;
a second connection line having a first end connected to the refrigerant line between the compressor and the first heat-exchanger and having a second end connected to the control device;
a third connection line having a first end connected to the refrigerant line between the first heat-exchanger and the second heat-exchanger and having a second end connected to the refrigerant line between the second heat-exchanger and the third heat-exchanger;
a fourth connection line having a first end connected to the refrigerant line between the second heat-exchanger and the third heat-exchanger and having a second end connected to the refrigerant line between the third heat-exchanger and the compressor; and
a fifth connection line having a first end connected to the refrigerant line between the third heat-exchanger and the compressor and having a second end connected to the refrigerant line between the first heat-exchanger and the second heat-exchanger.

2. The heat pump system of claim 1, wherein the air conditioner unit further comprises:
a sixth connection line having a first end connected to the third connection line and having a second end connected to a first end of the fourth connection line;
a first valve disposed on the refrigerant line between the third heat-exchanger and the compressor;
a second valve disposed on the third connection line;
a third valve disposed on the fifth connection line;
a fourth valve disposed on the sixth connection line;
a second expansion valve disposed on the first connection line; and
a third expansion valve disposed on the fourth connection line.

3. The heat pump system of claim 2, wherein the air conditioner unit further comprises:
an accumulator disposed on the refrigerant line between the third heat-exchanger and the compressor; and
an internal heat-exchanger disposed inside the accumulator, the internal heat-exchanger configured to exchange heat between the refrigerant supplied from the second heat-exchanger and the refrigerant supplied from the third heat-exchanger with each other, and to supply the refrigerant with a higher temperature among the heat-exchanged refrigerant to the third heat-exchanger.

4. The heat pump system of claim 3, wherein, when cooling of a battery module is required in a cooling mode of a vehicle interior:
a portion of the refrigerant line connecting the compressor and the first heat-exchanger and a portion of the refrigerant line connecting the first heat-exchanger and the control device are closed by an operation of the control device;
the first connection line is opened by an operation of the second expansion valve;
the second connection line is opened by the operation of the control device;
the third connection line is closed by an operation of the second valve;
the fourth connection line is closed by an operation of the third expansion valve;
the fifth connection line is closed by an operation of the third valve; and
the sixth connection line is closed by an operation of the fourth valve.

5. The heat pump system of claim 4, wherein:
the first expansion valve is configured to expand the refrigerant introduced through the refrigerant line and to introduce the expanded refrigerant to the third heat-exchanger; and
the second expansion valve is configured to expand the refrigerant introduced through the first connection line and to introduce the expanded refrigerant to the chiller to cool the battery module by using the coolant having exchanged heat with the refrigerant at the chiller.

6. The heat pump system of claim 4, wherein:
the refrigerant discharged from the compressor is introduced into the control device along the second connection line;
the refrigerant discharged from the control device is introduced into the second heat-exchanger;
a partial refrigerant among the refrigerant discharged from the internal heat-exchanger is introduced into the chiller along the first connection line;
a remaining refrigerant among the refrigerant discharged from the internal heat-exchanger is introduced into the first expansion valve along the refrigerant line; and
the refrigerant discharged from the chiller and the refrigerant discharged from the third heat-exchanger are supplied to the compressor, after passing through the internal heat-exchanger and the accumulator along the refrigerant line.

7. The heat pump system of claim 3, wherein, in a heating mode of a vehicle interior:
a portion of the refrigerant line connecting a first end of the first connection line to a second end of the third connection line is closed by an operation of the first expansion valve;
a portion of the refrigerant line connecting a first end of the third connection line to the control device is closed by an operation of the control device;
a portion of the refrigerant line connecting the control device and a second end of the fifth connection line is closed by the operation of the control device;
a portion of the refrigerant line connecting a second end of the fourth connection line and a second end of the first connection line is closed by an operation of the first valve;
the first connection line is opened by an operation of the second expansion valve;
the second connection line is closed by the operation of the control device;
the third connection line is opened by an operation of the second valve;
the fourth connection line is opened by an operation of the third expansion valve;
the fifth connection line is opened by an operation of the third valve; and
the sixth connection line is closed by an operation of the fourth valve.

8. The heat pump system of claim 7, wherein the third expansion valve is configured to expand the refrigerant such that the expanded refrigerant is supplied to the second heat-exchanger, the internal heat-exchanger, and the chiller, respectively.

9. The heat pump system of claim 7, wherein:
a partial refrigerant among the refrigerant introduced from the third heat-exchanger to the fourth connection line is introduced into the second heat-exchanger; and
a remaining refrigerant among the refrigerant introduced from the third heat-exchanger to the fourth connection line is introduced into the internal heat-exchanger.

10. The heat pump system of claim 7, wherein:
a partial refrigerant among the refrigerant discharged from the third expansion valve is introduced into the chiller, after passing through the internal heat-exchanger along the refrigerant line; and
the refrigerant discharged from the second heat-exchanger and the chiller is supplied to the compressor, after passing through the internal heat-exchanger and the accumulator.

11. The heat pump system of claim 7, wherein the second expansion valve is configured to supply the refrigerant introduced through the first connection line to the chiller without expansion.

12. The heat pump system of claim 3, wherein, in a heating and dehumidification mode of a vehicle interior:
a portion of the refrigerant line connecting a first end of the first connection line and a second end of the third connection line is opened by an operation of the first expansion valve;
a portion of the refrigerant line connecting a first end of the third connection line and the second heat-exchanger is closed by an operation of the control device;
the refrigerant line connecting the third heat-exchanger and the accumulator is opened by an operation of the first valve;
a portion of the refrigerant line connecting the second heat-exchanger and the internal heat-exchanger is closed;
the first connection line is closed by an operation of the second expansion valve;
the second connection line is closed by the operation of the control device;
a portion of the third connection line connected to the sixth connection line from the first end of the third connection line is opened;
a portion of the third connection line connecting the second end of the third connection line to a first end of the sixth connection line is closed by an operation of the second valve;
the fourth connection line is closed by an operation of the third expansion valve;
the fifth connection line is closed by an operation of the third valve; and
the sixth connection line is opened by an operation of the fourth valve.

13. The heat pump system of claim 12, wherein the first expansion valve is configured to expand the refrigerant introduced from the first heat-exchanger through the third connection line, the sixth connection line, and the refrigerant line, and configured to supply the expanded refrigerant to the third heat-exchanger.

14. The heat pump system of claim 1, wherein the second heat-exchanger and the third heat-exchanger are configured to cool or evaporate an interiorly introduced refrigerant.

15. The heat pump system of claim 1, wherein:
a first end of the first connection line is connected to the refrigerant line between the second heat-exchanger and the first expansion valve;
a second end of the first connection line is connected to the refrigerant line between the third heat-exchanger and the compressor; and
a second end of the second connection line is connected to the refrigerant line between the first heat-exchanger and the second heat-exchanger.

16. The heat pump system of claim 1, wherein the control device comprises:
a first control valve disposed on the refrigerant line between the first heat-exchanger and the second heat-exchanger; and
a second control valve disposed on the second connection line, the second control valve configured to control a flow of the refrigerant flowing through the second connection line.

17. The heat pump system of claim 3, wherein the control device comprises:
a first control valve disposed on the refrigerant line between the first heat-exchanger and the second heat-exchanger; and
a second control valve disposed on the second connection line, the second control valve configured to selectively expand the refrigerant flowing through the second connection line,
wherein a fifth valve is disposed on the refrigerant line between the second heat-exchanger and a second end of the fifth connection line.

18. The heat pump system of claim 17, wherein, in a hot gas heating mode of a vehicle interior:
a portion of the refrigerant line connecting a first end of the first connection line to a second end of the third connection line is closed by an operation of the first expansion valve;
a portion of the refrigerant line connecting a first end of the third connection line to the control device is closed by an operation of the control device;
a portion of the refrigerant line connecting the control device and the second end of the fifth connection line is opened by the operation of the control device;
a portion of the refrigerant line connecting a second end of the fourth connection line and a second end of the first connection line is closed by an operation of the first valve;
a portion of the refrigerant line connected to the first end of the fourth connection line, by passing through the second heat exchanger from the second end of the fifth connection line, is closed by an operation of the fifth valve;
the first connection line is opened by an operation of the second expansion valve;
the second connection line is opened by the operation of the control device;
the third connection line is opened by an operation of the second valve;
the fourth connection line is opened by an operation of the third expansion valve;
the fifth connection line is opened by an operation of the third valve; and
the sixth connection line is closed by an operation of the fourth valve.

19. The heat pump system of claim 18, wherein:
a partial refrigerant among the refrigerant supplied from the compressor is introduced into the first heat-exchanger along the refrigerant line;
a remaining refrigerant among the refrigerant supplied from the compressor is introduced into the control device along the second connection line;
the control device is configured to expand the refrigerant introduced into the second connection line such that the expanded refrigerant flows along the fifth connection line;
the third expansion valve is configured to expand the refrigerant such that the expanded refrigerant is supplied to the internal heat-exchanger and the chiller, respectively; and
the second expansion valve is configured to supply the refrigerant introduced through the first connection line to the chiller without expansion.

20. The heat pump system of claim 1, wherein the refrigerant is an R744 refrigerant formed of carbon dioxide.
